(19) United States
(12) Patent Application Publication
(10) Pub. No.: US 2018/0326822 A1
(43) Pub. Date: Nov. 15, 2018

(54) DRIVE SYSTEM FOR A MOVABLE ROOF PART OF A SPOILER ROOF MODULE OF A MOTOR VEHICLE

(71) Applicant: Michael HEIDAN, Stuttgart (DE)

(72) Inventor: Michael HEIDAN, Stuttgart (DE)

(21) Appl. No.: 15/974,788

(22) Filed: May 9, 2018

(30) Foreign Application Priority Data
May 10, 2017 (DE) 10 2017 207 892.8

(51) Int. Cl. B60J 7/043; B60J 7/057

(52) U.S. Cl. CPC B60J 7/0435; B60J 7/0573

(57) ABSTRACT

A drive system having a control slide movable by a drive transmission train in a guide rail arrangement, and having a support profile, to which the movable roof part is fastened. Front and rear deploying mechanisms move the support profile between closed, ventilating and open positions. The front deploying mechanism has a deploying lever movable in a guide channel of the guide rail arrangement by a lower sliding joint, which guide channel has a front supporting bearing holding a front section of the support profile in a pivotably movable manner. The guide channel is connected to the control slide by a rear control bearing. The deploying lever and the control slide each have a control track. The rear control bearing is guided in the control track of the control slide, and the control slide has a control cam guided in the deploying lever control track.

### CROSS-REFERENCE TO RELATED APPLICATIONS

This claims priority from German Application No. 10 2017 207 892.8, filed on May 10, 2017, the disclosure of which is hereby incorporated by reference in its entirety.

### FIELD, BACKGROUND AND SUMMARY OF THE INVENTION

The invention relates to a drive system for a movable roof part of a spoiler roof module of a motor vehicle, having a control slide which can be moved longitudinally by means of a drive transmission train in a guide rail arrangement, and having a support profile, to which the movable roof part is fastened and which is assigned a front deploying mechanism and a rear deploying mechanism, in order to move the support profile between a closed position, a ventilator position and an open position, the front deploying mechanism having a deploying lever which can be moved in a guide channel of the guide rail arrangement by way of a lower sliding joint, which guide channel has a front supporting bearing for holding a front section of the support profile in a pivotably movable manner, and which guide channel is connected to the control slide by means of a rear control bearing.

A drive system of this type is generally known for a spoiler roof module of a passenger motor vehicle. The spoiler roof module can be mounted in a roof cutout of a vehicle body of the passenger motor vehicle and has a movable roof part which can be moved between a closed position which closes a roof opening, a ventilator position which is deployed obliquely rearward and upward, and an open position which is moved rearward over a stationary roof section. In order to move the movable roof part, a drive system is provided which has identically designed drive and functional components on opposite sides of the roof opening. Each side has a control slide which can be moved longitudinally by means of a drive transmission cable in a guide rail arrangement which is fixed to the vehicle. The drive transmission cable is guided longitudinally displaceably in a frame of the spoiler roof module, which frame also comprises the guide rail arrangement, and is moved forward or rearward in the longitudinal direction of the guide rail arrangement by way of an electric drive motor. In each case one support profile is provided in the region of an underside of the movable roof part on opposite sides, which support profiles are connected fixedly to the underside of the movable roof part. The respective support profile extends substantially in the vehicle longitudinal direction and is supported by a front deploying mechanism and by a rear deploying mechanism which are functional parts of the drive system. In order to move the front deploying mechanism and the rear deploying mechanism in the vertical direction and/or in the longitudinal direction, the two mechanisms are connected to the control slide. The front deploying mechanism has a rocker arm-like deploying lever which is mounted with a front lever projection pivotably movably on the support profile and with a rear-side lever projection pivotably movably on the control slide. In the region of its underside, the deploying lever is provided with a sliding pad which is guided longitudinally displaceably in a guide channel of the guide rail arrangement.

It is an object of the invention to provide a drive system of the type mentioned at the outset, which permits a compact construction.

Said object is achieved by virtue of the fact that the deploying lever and the control slide in each case have a control track, that the rear control bearing of the deploying lever is guided in the control track of the control slide, and that the control slide has a control cam which is guided in the control track of the deploying lever. The mutual guidance of the deploying lever and the control slide via corresponding control tracks makes a comparatively short (as viewed in the longitudinal direction of the guide rail arrangement) design of the control slide possible, which results overall in a compact embodiment of the drive system. The terms “front”, “rear”, “longitudinal”, “transverse”, “upright”, vertical or horizontal, as used in this application, are in relation to a coordinate system of the spoiler roof module in the state, in which it is installed ready for operation in a roof region of the motor vehicle, with the result that the corresponding directions, planes and axes correspond to a coordinate system of the motor vehicle, that is to say the vehicle longitudinal direction, the vehicle transverse direction and the vehicle vertical direction. They correspond to horizontal and vertical axes in the case of a vehicle which is standing on a horizontal subsurface. The control tracks are preferably provided in vertical planes which are parallel to one another.

The solution according to the invention is provided for a spoiler roof module. A spoiler roof module is to be understood to mean a sliding roof system which has a movable roof part which is moved into an open position over a stationary, rear roof section, functional components of the drive system remaining in correspondingly lateral regions of the roof opening of the spoiler roof module. Accordingly, the movable roof part protrudes partially in a “freely floating” manner over the stationary roof section in its open position. In the open position, a front region of the movable roof part is held by the functional components of the drive system, with the result that the roof opening of the spoiler roof module can also be released merely partially in the open position in comparison with a sliding roof system which is designed in accordance with the inner slider or the outer slider functional principle. The solution according to the invention is suitable in a particularly advantageous way for use in a roof region of a passenger motor vehicle. In the same way, however, a use is also provided for other land vehicles or watercraft.

In one refinement of the invention, the guide channel of the guide rail arrangement has a sliding bevel in a front region, along which sliding bevel the lower sliding joint can be moved upward and downward. At the rear, the sliding bevel adjoins a channel section of the guide rail arrangement, which channel section is elongate in the longitudinal direction of the guide rail arrangement. The lower sliding joint of the deploying lever, which lower sliding joint is preferably configured as a sliding pad, can be displaced in a slidingly movable manner along the sliding bevel and along the adjoining channel section of the guide rail arrangement.

In a further refinement of the invention, the sliding bevel is recessed downward with respect to a sliding plane for the control slide. In the case of a sliding movement rearward of the sliding joint of the deploying lever, this necessarily results in lifting of the entire front deploying lever, as a result of which the front region of the support profile and therefore a front region of the movable roof part also move upward, in order for it to be possible for the movable roof part to be moved in the direction of its open position.

In a further refinement of the invention, the deploying lever has a laterally protruding supporting pin which supports a front region of the control slide in the region of the sliding bevel at least on the underside. Secure positive guidance of the control slide and the deploying lever in the region of the sliding bevel is ensured by way of the mutual support of the deploying lever and the control slide by means of the supporting pin in the front region of the control slide. Undefined yielding movements of the control slide or the deploying lever are avoided as a result.

In a further refinement of the invention, the supporting pin is arranged above the sliding joint of the deploying lever. The supporting pin protrudes toward that side, on which the control slide is moved with its front region in parallel along the deploying lever.

### BRIEF DESCRIPTION OF THE DRAWINGS

Further advantages and features of the invention result from the claims and from the following description of preferred exemplary embodiments of the invention which are shown using the drawings, in which:

FIG. 1 shows a perspective illustration of a spoiler roof module for a roof region of a passenger motor vehicle in a closed position of a movable roof part,

FIG. 2 shows the spoiler roof module in accordance with FIG. 1 with the movable roof part which is moved into its open position,

FIG. 3 shows an exploded illustration obliquely from the front and from the outside (in relation to a vehicle center) of one embodiment of a drive system according to the invention for the spoiler roof module in accordance with FIGS. 1 and 2,

FIG. 4 shows the drive system in accordance with FIG. 3 in an exploded illustration obliquely from the front and from the inside,

FIG. 5 shows a side view of the drive system in accordance with FIGS. 3 and 4,

FIG. 6 shows a side view from the inside of a front part region of the drive system in accordance with FIGS. 3 to 5,

FIG. 7 shows the front region in accordance with FIG. 6 with the omission of a carrier strip of the drive system,

FIG. 8 shows the front region in accordance with FIGS. 6 and 7 in a further functional position which is moved in comparison with FIGS. 6 and 7,

FIGS. 9 to 12 show an isometric illustration from the outside of the front region of the drive system in different functional positions of a deploying lever of a front deploying mechanism of the drive system,

FIG. 13 shows a perspective illustration obliquely from the inside and from the rear of a rear deploying mechanism of the drive system in accordance with FIGS. 3 and 4,

FIGS. 14 to 19 show a side view from the outside of the rear deploying mechanism in accordance with FIG. 13 in different functional positions between a rest position (FIG. 14) and a completely erected open position (FIG. 19),

FIG. 20 shows a perspective illustration of a control rod and a side panel of the drive system in accordance with FIGS. 3 and 4,

FIG. 21 shows a plan view of the control rod and the side panel in accordance with FIG. 20,

FIGS. 22 and 23 show a side view of the side panel of the drive system in accordance with FIGS. 3 and 4 in different functional positions,

FIG. 24 shows a detail of a further embodiment of a drive system according to the invention in a similar manner to FIGS. 3, 4, 22 and 23 with a diagrammatic illustration of a virtual pivot point, and

FIGS. 25 to 28 show a horizontal section of a detail of the drive system in accordance with FIGS. 3 and 4 in the region of a securing means, which is fixed on the guide rail, of the control rod of the rear deploying mechanism in different functional positions.

### DETAILED DESCRIPTION

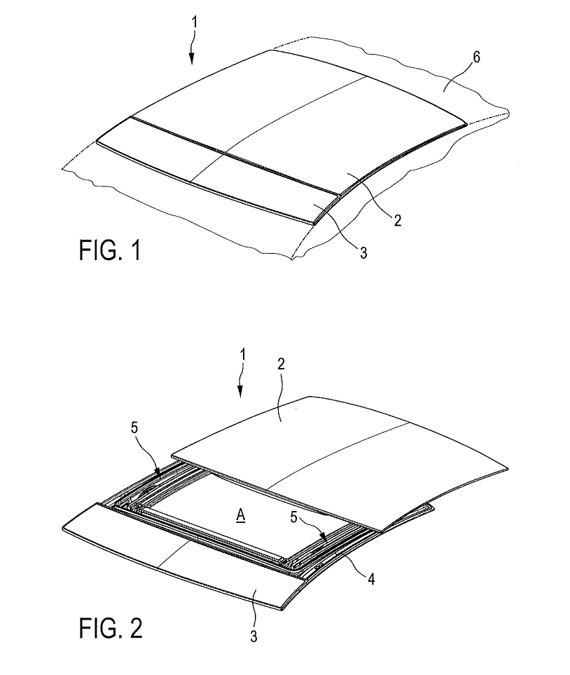

In accordance with FIGS. 1 and 2, a passenger motor vehicle has a roof region 6 which is provided with a spoiler roof module 1. To this end, the roof region 6 of the vehicle body of the passenger motor vehicle is provided with a roof cutout, into which the spoiler roof module 1 is inserted. The spoiler roof module 1 has a support frame 4 which borders a roof opening A. The roof opening A can be closed by way of a movable roof part 2. A closed position of the movable roof part 2 is shown in FIG. 1. FIG. 2 shows an open position of the movable roof part 2. On the front side, in relation to a normal driving direction of the passenger motor vehicle, the support frame 4 is provided with a front part 3 which extends over a width of the support frame 4 and is covered on the upper side by way of a front panel. Below the front panel, a drive unit for two drive systems 5 is provided, which drive systems 5 are of identical design to one another and are arranged in lateral length sections of the support frame 4. The drive systems 5 on opposite longitudinal sides of the roof opening A are of identical design to one another and can be actuated in a synchronized manner with respect to one another by means of the drive unit (not shown). The roof part 2 is connected fixedly to in each case one support profile 11 of the respective drive system 5 in the region of its underside on opposite longitudinal sides. The support profile 11 is mounted in the vehicle vertical direction and in the vehicle longitudinal direction by means of functional components of the respective drive system 5 which are described in the following text, in order to bring about the movement of the movable roof part 2 between the closed position, an obliquely rearwardly and upwardly deployed ventilator position, and the open position which is shown in FIG. 2. By virtue of the fact that the two drive systems can be moved in a synchronized manner with respect to one another, the two support profiles of the roof part 2 are also moved synchronously with respect to one another, which results in the desired parallel movement of the roof part 2 between the closed position and the open position.

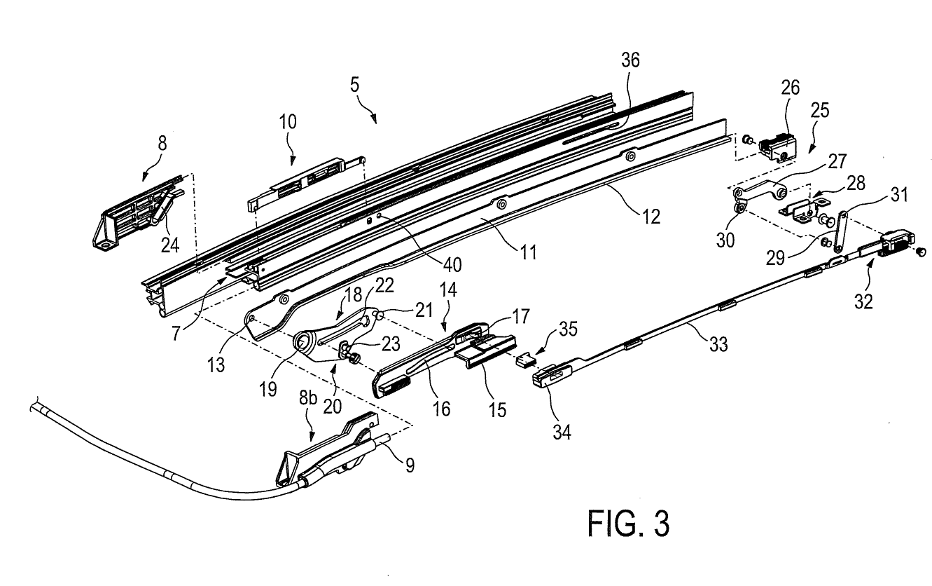

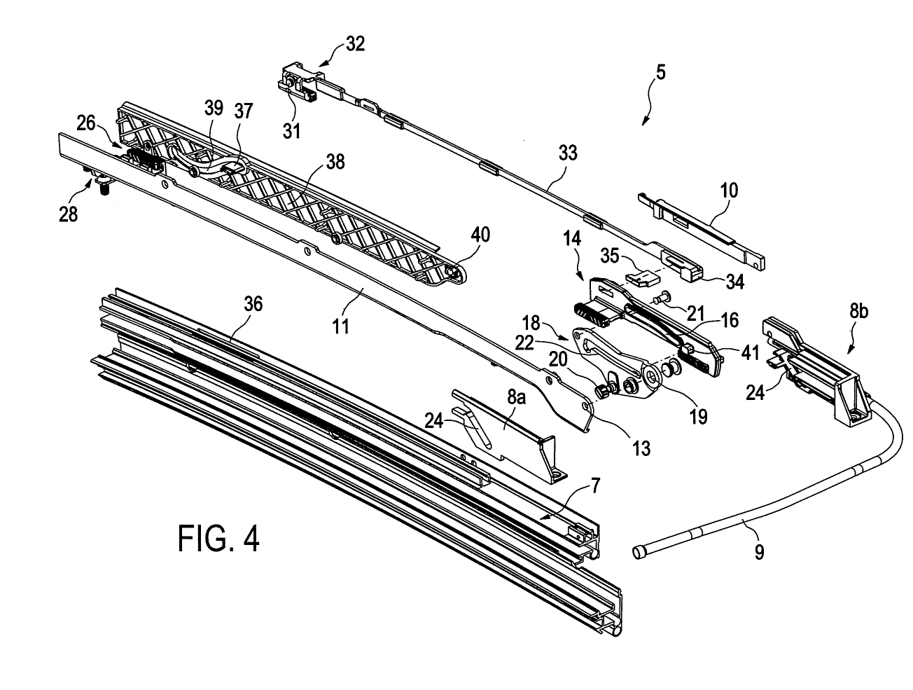

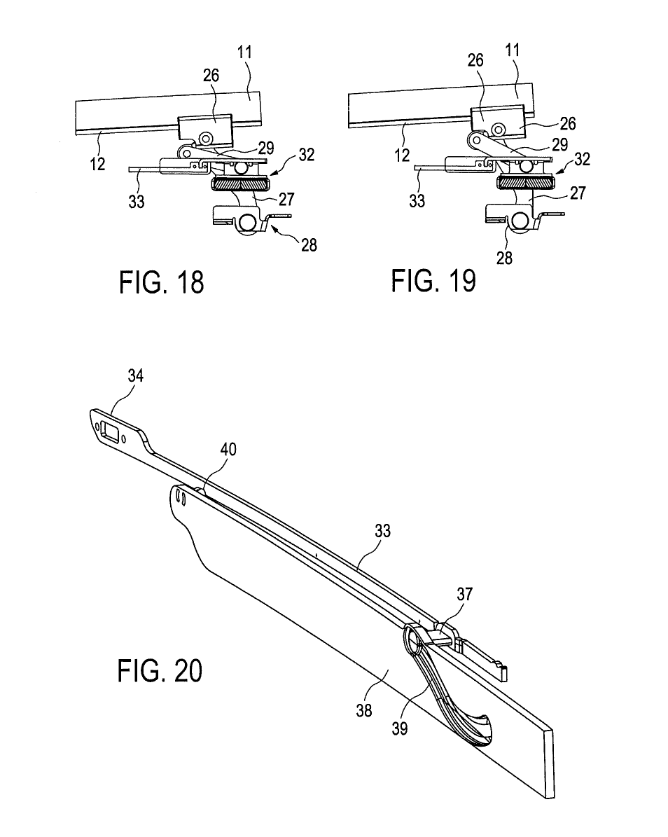

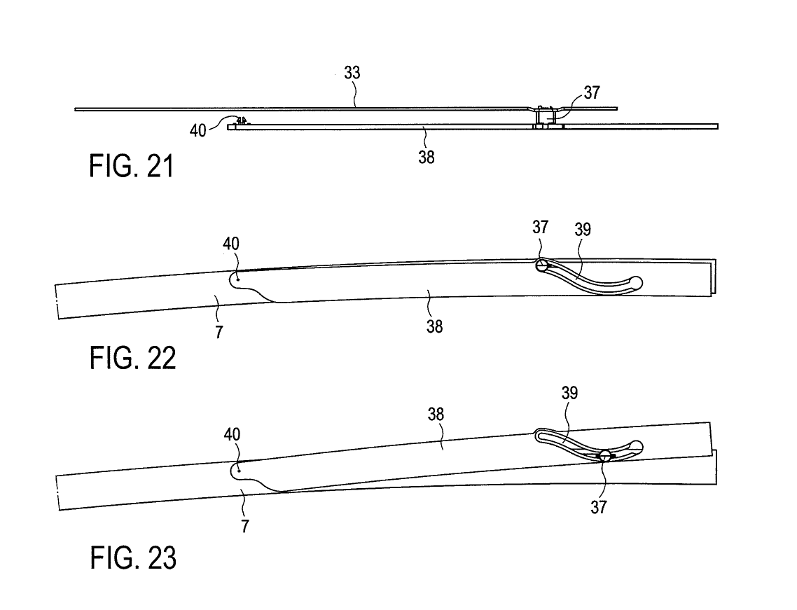

In the following text, the left-hand (as viewed in the normal driving direction) drive system 5 will be described in greater detail using FIGS. 3 to 28. The opposite drive system 5 is of mirror-symmetrical design with respect to a vertical vehicle center longitudinal plane, but otherwise of identical design, with the result that reference is made to the comments with respect to the left-hand drive system 5 in order to avoid repetitions.

The support profile 11 can be moved between the closed position and the open position in the vehicle longitudinal direction and in the vehicle vertical direction by means of a front deploying mechanism which is described in the following text and by means of a rear deploying mechanism 25. The front and the rear deploying mechanisms are functional components of a control mechanism of the drive system 5. An activation and movement of the front deploying mechanism and of the rear deploying mechanism 25 take place by means of a control slide 14, on which a drive member 15 is arranged fixedly which is connected to a drive transmission train which is guided longitudinally displaceably in a sheathing tube 9 in the front region of the support frame 4 and otherwise in a longitudinal channel of a guide rail 7. The control slide 14 including its drive member 15 is guided longitudinally displaceably in a guide channel of the guide rail arrangement 7. To this end, the control slide 14 has a plurality of sliding pads which are not denoted in greater detail. The guide rail arrangement 7 is part of the support frame 4 and is accordingly arranged fixedly on the vehicle in the assembled state of the support frame 4 such that it is ready for operation. The drive transmission train is configured as a thread pitch cable or as a flexible rack. The drive transmission train is deflected in the front region of the support frame 4 by means of the sheathing tube 9 toward a center, where the drive transmission train is operatively connected to the central drive unit. The central drive unit has an electric drive motor and a suitable worm gear mechanism which, upon activation of the drive motor, can displace the thread pitch cable in a suitable way in opposite directions within the sheathing tube and the channel section of the guide rail arrangement 7.

The front deploying mechanism has a deploying lever 18 which, in the region of its underside, is guided in a slidingly movable manner in a guide channel of the guide rail arrangement 7 by means of a sliding pad 20. The sliding pad 20 forms a lower sliding joint within the context of the invention. The guide channel of the guide rail arrangement 7 merges in a front region of the guide rail arrangement 7 into a sliding bevel 24 of a double-shell front part 8, 8a, 8b of the guide rail arrangement 7. The front part 8, 8a, 8b is produced from plastic. The sliding bevel 24 extends, starting from a section which is flush with the guide channel of the guide rail arrangement 7, obliquely forward and downward below a horizontal plane of the guide channel of the guide rail arrangement 7.

In addition, on the front side, the deploying lever 18 has a supporting bearing 19, by means of which the deploying lever 18 is mounted in a pivotably movable manner on a front-side receptacle 13 of the support profile 11. On the rear side, the deploying lever 18 has a control bearing 21 which engages into a control track 16 of a control slide 14. Here, the control bearing 21 is held in the control track 16 both such that it can move slidingly and such that it can be moved rotationally about a rotational axis which extends in the vehicle transverse direction. The deploying lever 18 itself likewise has a control track 22, into which a control cam 41 of the control slide 14 engages. The control cam 41 protrudes inward to the deploying lever 18, whereas the control bearing 21 of the deploying lever 18 protrudes laterally outward to the control slide 14 and into the control track 16. The control slide 14 is guided such that it can be displaced longitudinally in a slidingly movable manner in the guide channel of the guide rail arrangement 7.

The control track 22 of the deploying lever 18 extends substantially in the longitudinal direction and, at its rear end region, is provided with a downwardly extending pocket, into which the control cam 41 can dip and can be held in the control track 22 in a positively locking manner in the longitudinal direction. The control track 16 of the control slide 14 extends substantially in the longitudinal direction and is curved slightly toward the front and bottom in the region of a front half.

Above the sliding pad 20, the deploying lever 18 is provided with a laterally outwardly protruding supporting pin 23 which is of cylindrical design in the exemplary embodiment which is shown. The supporting pin 23 is connected fixedly to a side wall of the deploying lever 18. The supporting pin 23 protrudes toward the control slide 14 in such a way that, depending on the relative movement between the deploying lever 18 and the control slide 14, the supporting pin 23 is in contact with a front-side end edge or a front-side lower edge of the control slide 14, in order to achieve mutual support between the deploying lever 18 and the control slide 14.

The rear deploying mechanism 25 has a bearing block 28 which is connected fixedly to the support frame 4 below the guide rail arrangement 7 and is therefore mounted fixedly on the vehicle. Instead of to the support frame 4, the bearing block 28 can also be fastened in the region of an underside of the guide rail arrangement 7. A pivoting lever 27 is mounted on the bearing block 28 such that it can be moved pivotably in a pivoting plane which extends in the vehicle vertical direction and in the vehicle longitudinal direction. In its end region which lies away from the bearing block 28, the pivoting lever 27 is connected pivotably movably to a control slider 26 which encloses a control web 12 of the support profile 11 such that it can be moved slidingly. The control web 12 protrudes laterally to the outside from an underside of the support profile 11, is an integral projection of the support profile 11, and extends over an entire length of the support profile 11. By means of the pivoting lever 27, the support strip 11 can be deployed upward or can be lowered downward in the region of the encompassing by way of the control slider 26.

In order to bring about lowering or lifting of the control slider 26 and therefore of the rear region of the support strip 11 in a manner which is dependent on a displacement movement of the control slide 14, the rear deploying mechanism 25 is assigned a control rod 32 to 34 which acts by means of a forced control means on the pivoting lever 27, and which is either fixed firmly on the vehicle or is connected fixedly to the control slide 14. The control rod 32 to 34 has a rear-side guide slide 32 which is guided longitudinally displaceably in the guide rail arrangement 7. A control lever 29 is mounted as a forced control means on the guide slide 32 such that it can be moved pivotably by means of a pivoting bearing 31. By way of its end region which lies away from the pivoting bearing 31, the control lever 29 acts on a pivoting bearing 30 of the pivoting lever 27, which pivoting bearing 30 is provided immediately adjacently with respect to the articulation on the control slider 26.

The guide slide 32 is connected fixedly to a functional pocket 34 by means of a rod projection 33 which extends forward in the longitudinal direction of the guide rail arrangement, in which functional pocket 34 a sliding bar 35 is held such that it can be displaced in the vehicle transverse direction. The sliding bar 35 can be brought into an operative connection in a positively locking manner either with a receiving pocket 17 of the control slide 14 or with a latching receptacle 10 which is fastened to a side wall of the guide rail arrangement 7. It can be seen using FIGS. 25 to 28 that the sliding bar 35 brings about either a positively locking connection between the functional pocket 34 and the control slide 14 (see FIG. 25) or a positively locking connection between a cutout of the stationary latching receptacle 10 and the functional pocket 34. Accordingly, the control rod 32 to 34 is either held in the guide rail arrangement 7 in a stationary manner, or it is driven rearward or forward by way of the control slide 14 for a displacement movement. The control rod 32 to 34 latches with the latching receptacle 10 and therefore latches with the guide rail arrangement in a stationary manner in the position, in which the rear deploying mechanism 25 has reached its upper end position. For a return from the upper end position, the control slide 14 drives the control rod 32 to 34 forward via driving of the sliding bar 35 over a limited travel in the vehicle longitudinal direction, as a result of which the rear deploying mechanism 25 can be lowered as far as into the rest position.

In order to hide a view from the outside on the rear deploying mechanism 25 and, in addition, in order for it to be possible to bring about acoustic protection for the vehicle interior compartment in the case of a roof part 2 which has been transferred into a ventilator position or another open position, the drive system 5 is additionally provided with a side panel 38 which is mounted laterally on the outside on a side wall of the guide rail arrangement 7 such that it can be moved pivotably by means of a pivoting bearing 40. The pivoting bearing 40 defines a pivot axis which extends in the vehicle transverse direction. The side panel 38 extends in the longitudinal direction and in an upright manner in the vertical direction, toward the rear starting from the pivoting bearing 40. The side panel 38 has a curved slotted guide 39 which is designed as an arcuate guide and into which a pin-like slotted link member 37 engages. The pin-like slotted link member 37 is mounted longitudinally displaceably in a guide slot 36 of the side wall of the guide rail arrangement 7, which guide slot 36 extends in the vehicle longitudinal direction. To this end, the slotted link member 37 is provided with a flattened guide section which is guided linearly movably in the guide slot 36 and penetrates the guide slot 36 in the vehicle transverse direction. On the outer side, the slotted link member 37 protrudes by means of a round sliding block into the curved slotted guide 39 of the side panel 38. The side panel 38 is provided on the outer side with a continuous protective layer, with the result that the curved slotted guide 39 cannot be seen from an outer side. The protective layer can be produced in a two-component design in one piece with the side panel 38 which consists of plastic, or can be attached subsequently to said side panel 38.

The guide section of the slotted link member 37 is fastened on the inner side to the control rod 32 to 34. The slotted link member 37 is preferably latched with a latching cutout of the rod projection 33 of the control rod 32 to 34.

When the control rod 32 to 34 is moved together with the control slide 14, the slotted link member 37 necessarily slides along in the slotted guide 39, as a result of which the side panel 38 necessarily carries out a limited pivoting movement about the pivoting bearing 40 on account of the curvature of the slotted guide 39. In this way, the side panel 38 is lowered in the rest position of the rear deploying mechanism 25, whereas it is necessarily pivoted out obliquely upward during the transfer into the deployed position, and thus prevents a view on the rear deploying mechanism 25 from the outside. This is because the side panel 38 necessarily covers the rear deploying mechanism 25 which has been deployed upward.

The forced control means of the side panel 38 can be seen clearly in FIGS. 20 to 23 using different functional positions.

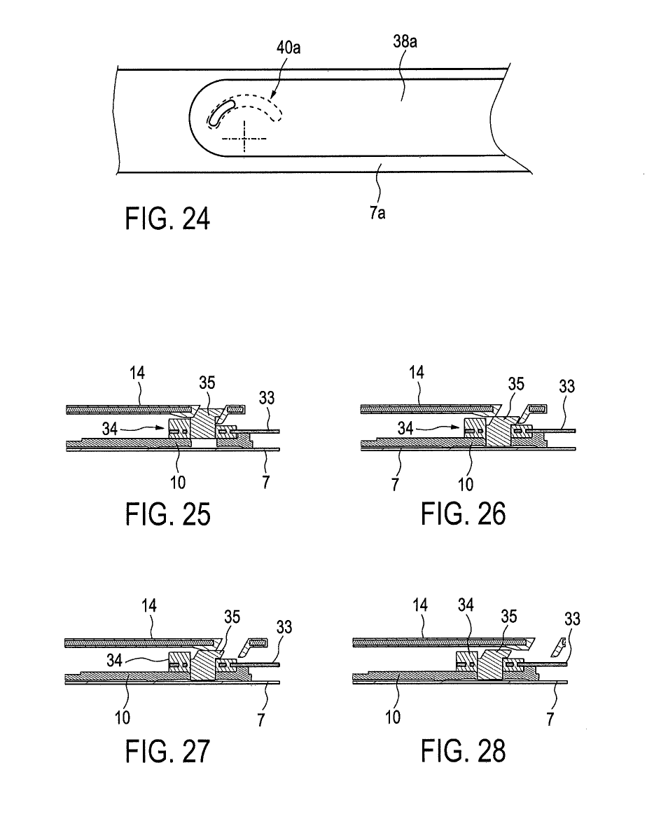

In accordance with FIG. 24, in a further embodiment of the invention, the side panel 38a is moved in the region of a front pivoting bearing 40a about a virtual pivot point relative to a guide rail arrangement 7a, by a circularly arcuate slotted guide firstly and a circularly arcuate sliding block secondly being provided as pivoting bearing 40a. If the sliding block is provided as a guide cam laterally on the outside on the side wall of the guide rail arrangement 7a and the circular arc section-shaped slotted guide is provided on the front region of the side panel 38a, the side panel 38a can also carry out a displacement movement toward the rear in addition to a pivoting movement, which results in a merely virtual pivot point.

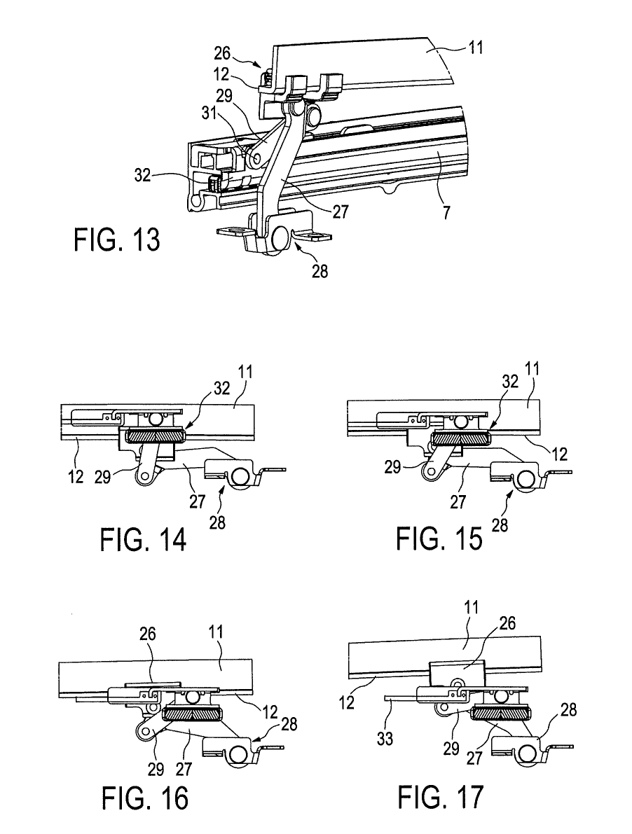

Different functional positions of the rear deploying mechanism 25 are readily understandable using FIGS. 13 to 19. It can be seen here that the control lever 29 together with the pivoting lever 27 operates in accordance with the toggle lever principle. The control lever 29 is driven by way of the guide slide 32 in the case of a displacement movement rearward and, as can be seen using FIGS. 15 to 19, hereby necessarily pulls the pivoting lever 27 upward until the latter has reached its upper end position. The movement of the pivoting lever 27 and therefore of the control slider 26 by means of the control lever has an additional advantage. It is possible to secure the control slider 26 in different deployed positions. It is thus possible according to the invention, in particular, to achieve dynamic lowering of the lift of the control slider 26 and therefore of the support profile 11 when the support profile 11 is transferred into its ventilator position. This leads to it being possible for the movable roof part 2 to be lowered into a somewhat flatter ventilator position at high driving speeds, as a result of which buffeting or other disruptive noise can be reduced in the vehicle interior compartment.

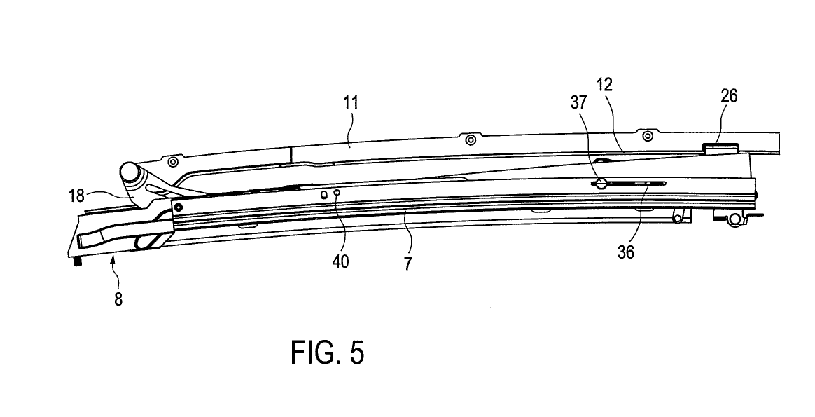

The support profile 11 which has been deployed upward both in the region of the front deploying mechanism and in the region of the rear deploying mechanism can be seen using FIG. 5.

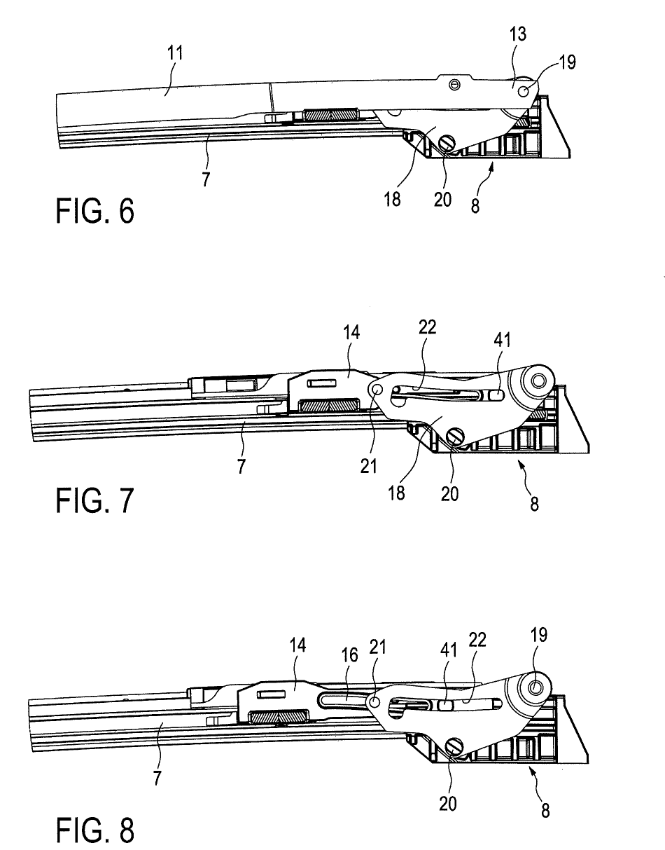

The mutual engagement of the front deploying lever 18 and the control slide 14 into one another can be seen using FIGS. 6 to 8, as can the overlap of the deploying lever 18 and the control slide 14 and the resulting compact design of the functional components in the longitudinal direction. The control cam 41 of the control slide 14 engages into the control track 22 of the deploying lever 18, whereas the control bearing 21 protrudes into the control track 16 of the control slide 14. FIGS. 7 and 8 show two different functional positions.

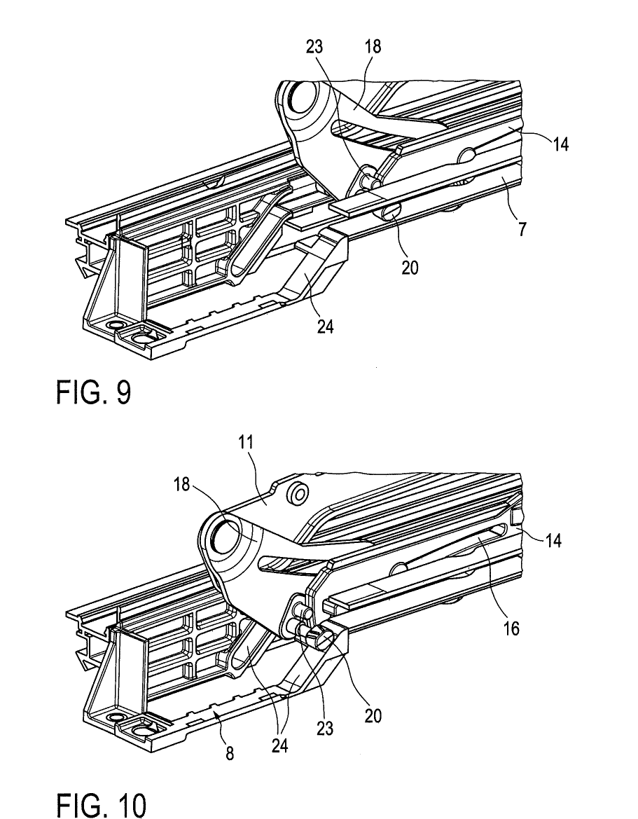

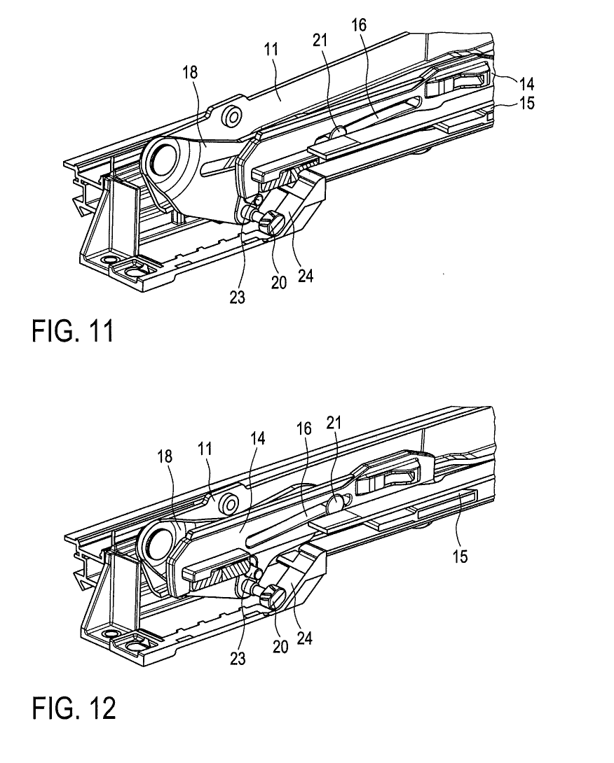

The above-described function of the supporting pin 23 can be seen clearly using FIGS. 9 to 12. The supporting pin 23 is supported on the front side on a front end edge of the control slide 14 in the positions in accordance with FIGS. 9 and 10. The supporting pin 23 is supported in the region of the lower edge of the front region of the control slide 14 in the position in accordance with FIG. 11.

1. Drive system for a movable roof part of a spoiler roof module of a motor vehicle, having a control slide which can be moved longitudinally by means of a drive transmission train in a guide rail arrangement, and having a support profile, to which the movable roof part is fastened and which is assigned a front deploying mechanism and a rear deploying mechanism, in order to move the support profile between a closed position, a ventilator position and an open position, the front deploying mechanism having a deploying lever which can be moved in a guide channel of the guide rail arrangement by way of a lower sliding joint, which guide channel has a front supporting bearing for holding a front section of the support profile in a pivotably movable manner, and which guide channel is connected to the control slide by means of a rear control bearing, wherein the deploying lever and the control slide in each case have a control track, in that the rear control bearing of the deploying lever is guided in the control track of the control slide, and in that the control slide has a control cam which is guided in the control track of the deploying lever.

2. Drive system according to claim 1, wherein the guide channel of the guide rail arrangement has a sliding bevel in a front region, along which sliding bevel the lower sliding joint can be moved upward or downward.

3. Drive system according to claim 2, wherein the sliding bevel is recessed downward with respect to a sliding plane for the control slide.

4. Drive system according to claim 1, wherein the deploying lever has a laterally protruding supporting pin which supports a front region of the control slide in the region of the sliding bevel at least on the underside.

5. Drive system according to claim 4, wherein the supporting pin is arranged above the sliding joint of the deploying lever.
